(19) United States
(12) Patent Application Publication
(10) Pub. No.: US 2004/0222553 A1
(43) Pub. Date: Nov. 11, 2004

(54) Method for making a stretch composite

(75) Inventors: Fred Naval Desai, Fairfield, OH (US); Urmish Popatlal Dalal, Milford, OH (US); Mark William Hamersky, Hamilton, OH (US); Steven Daryl Smith, Fairfield, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/429,433

(22) Filed: May 5, 2003

(51) Int. Cl. B29C 55/06; B32B 31/00

(52) U.S. Cl. 264/171.24; 264/288.4; 264/288.8; 264/320; 264/347; 264/348; 156/229; 156/160

(57) ABSTRACT

A method of forming a stretch composite with one or more elastomeric members disposed on at least one region of an extensible substrate to provide stretch properties to a targeted region of the substrate is disclosed. The composite has been incrementally stretched to at least partially break up the structure of the substrate in order to reduce its resistance to stretch. The stretch composites are useful for disposable and durable articles, such as disposable absorbent articles including diapers, pull-on diapers, training pants, incontinence briefs, catamenial garments, baby bibs, and the like, and durable articles like garments including sportswear, outerwear and the like. Methods of making such stretch composites are also disclosed.

### FIELD OF THE INVENTION

This invention relates to a method of forming a stretch composite having one or more elastomeric members disposed on at least one region of an extensible substrate to provide stretch properties targeted to that region of the substrate. The composite is incrementally stretched to at least partially break up the structure of the substrate in order to reduce its resistance to stretch. The stretch composites are useful for disposable and durable articles, such as disposable absorbent articles including diapers, pull-on diapers, training pants, incontinence briefs, catamenial garments, baby bibs, and the like, and durable articles like garments including sportswear, outerwear and the like.

### BACKGROUND

Disposable absorbent products, such as diapers, training pants, and incontinence articles, typically include stretchable materials, such as elastic strands, in the waist region and the cuff regions to provide a snug fit and a good seal of the article. Pant-type absorbent articles further include stretchable materials in the side portions for easy application and removal of the article and for sustained fit of the article. Stretchable materials have also been used in the ear portions for adjustable fit of the article.

There are various approaches to provide desirable elastic properties in those areas. Stretchable materials may be films or nonwoven fibrous webs made of elastomeric materials. Typically, such materials are stretchable in any direction. However, because the films or webs are made entirely of elastomeric materials, they are relatively expensive, and they tend to have more drag on skin surface, resulting in discomfort to the wearer of the article. Sometimes, the stretchable films are laminated to one or more layers of nonwoven webs. Since typical nonwoven webs are made of thermoplastic fibers, they have very limited stretchability and, the resulting laminates provide considerable resistance to stretch. It is necessary to reduce this resistance substantially in order to make functional stretch laminates.

Other approaches to make stretchable materials are also known, including: stretch-bonded laminates (SBL) and necked-bonded laminates (NBL). Stretch bonded laminates are made by stretching the elastic strands in the machine direction (MD), laminating the strands to one or more nonwoven substrates while they are in the stretched state, and releasing the tension in the elastic strands so that the nonwovens gather and take on a puckered shape. Necked-bonded laminates are made by first stretching the nonwoven substrate in the machine direction such that it necks (i.e., reduces its dimension) at least in the cross machine direction (CD), and then bonding the elastic strands to the substrate while the substrate is still in the stretched, necked state. This laminate will be stretchable in the CD, at least up to the original width of the nonwoven before it was necked. Combinations of stretch bondings and neck bondings have also been known to deliver stretch in both the MD and the CD. In these approaches, at least one of the components is in a tensioned (i.e., stretched) state when the components of the laminates are joined.

Zero strain stretch laminates are also known. The zero strain stretch laminates are made by bonding elastomers to the nonwoven while both are in an unstrained state. The laminates are then incrementally stretched to impart the stretch properties. The incrementally stretched laminates are stretchable only to the extent afforded by the non-recovered (i.e., residual) extensibility of the laminate. For example, U.S. Pat. No. 5,156,793, issued to Buell et al., discloses a method for incrementally stretching the elastomeric-nonwoven laminate web, in a non-uniform manner, to impart elasticity to the resulting laminate.

In all the approaches above, stretch laminates are made separately. The stretch laminates must be cut into the appropriate size and shape, then adhesively attached to the desired location in the product in a process sometimes referred as the “cut-and-slip” process. Because of the different stretch properties required for different elements of the product, it is necessary to make a variety of laminates having different stretchability and cut the laminates to different sizes and shapes. Several cut-and-slip units may be needed to handle the different stretchability of the stretch laminates and to attach them to different locations of the product. As the number of cut-and-slip units and/or steps multiplies, the process quickly becomes cumbersome and complicated.

Based on the foregoing, it is desirable to have a cost effective stretch composite having elastomeric materials disposed only in specific areas in specific amounts for stretchability to provide desired in-use benefits of an article, such as sealing, gasketing, containing, body-conforming, or fit. It is also desirable to have a stretch composite delivering stretchability in targeted areas among discrete, spaced apart components of the article. It is further desirable to have stretch composites delivering targeted stretchability locally (i.e., within a designated component of the article).

Moreover, it is desirable to have an efficient and cost effective process that does not involve multi-steps and/or multi-units and that delivers stretch properties to various portions of the absorbent article. Such a process for making the above stretch composites is desirable because it has total flexibility that allows for controlled deposition of different types and/or amount of elastomeric materials to the targeted areas only. Such a process is also desirable because it tailors the delivery of stretchability and resistance to stretch in various portions of a product to deliver improved fit and comfort to the wearer.

### SUMMARY OF THE INVENTION

The present invention relates to a process for making a stretch composite from an extensible substrate comprising the steps of:

a. providing a first extensible substrate;

b. printing one or more elastomeric compositions, said compositions having a melt viscosity of from about 1 to about 400 Pa#s, measured at 175° C. and 1 s⁻¹ strain rate, an elasticity of at least about 50 N/m at 20° C., and force relaxation of less than about 20%, onto said substrate thereby forming one or more intermediate structures; and

c. incrementally stretching one or more portions of the intermediate structure to permanently elongate the substrate in the portions.

All documents cited are, in relevant part, incorporated herein by reference; the citation of any document is not to be construed as an admission that it is prior art with respect to the present invention.

### BRIEF DESCRIPTION OF THE DRAWINGS

While the specification concludes with claims particularly pointing out and distinctly claiming the subject matter which is regarded as the present invention, it is believed that the invention will be more fully understood from the following description taken in conjunction with the accompanying drawings, in which:

FIG. 1A is a perspective view of one embodiment of a pant type diaper containing the stretch composite of the present invention;

FIG. 1B is a perspective view of another embodiment of a diaper in its in-use configuration containing the stretch composite of the present invention;

FIG. 2 is a schematic illustration of a representative process of the present invention;

FIG. 3A is a plan view of an exemplary stretch composite with first and second elastomeric compositions applied as rectilinear stripes in parallel patterns;

FIG. 3B is a plan view of an exemplary stretch composite with first elastomeric composition applied as rectilinear stripes in a parallel pattern and second elastomeric composition applied as rectilinear stripes in a non-parallel pattern;

FIG. 3C is a plan view of an exemplary stretch composite with first and second elastomeric compositions applied as rectilinear stripes in non-parallel patterns;

FIG. 4 is an enlarged perspective view of a primary operation of the present invention that includes applying elastomeric members to a substrate and joining with another substrate;

FIG. 5 is an enlarged perspective view of an optional secondary operation of the present invention which uses interengaging forming rolls to incrementally stretch an intermediate structure;

FIG. 6 is an enlarged perspective view of a pair of closely-spaced forming rolls each having alternating and interengaging peripheral teeth and grooves; and

FIG. 7 is an enlarged fragmentary cross-sectional view showing the tip portions of the teeth of the interengaging forming rolls with a web material positioned between the rolls and spanning and in contact with the tips of opposing teeth from the rolls.

### DETAILED DESCRIPTION OF THE INVENTION

The term “disposable” as used herein refers to products which generally are not intended to be laundered or otherwise restored or extensively reused in their original function, i.e., preferably they are intended to be discarded after about 10 uses, or more preferably after about 5 uses, or even more preferably after about a single use. It is preferred that such disposable articles be recycled, composted or otherwise disposed of in an environmentally compatible manner.

The term “disposable absorbent article” as used herein refers to a device that normally absorbs and retains fluids. In certain instances, the phrase refers to devices that are placed against or in proximity to the body of the wearer to absorb and contain the excreta and/or exudates discharged from the body, and includes such personal care articles as fastened diapers, pull-on diapers, training pants, swim diapers, adult incontinence articles, feminine hygiene articles, and the like. In other instances, the term also refers to protective or hygiene articles, for example, bibs, wipes, bandages, wraps, wound dressings, surgical drapes, and the like.

The term “fibrous substrate” as used herein refers to a material comprised of a multiplicity of fibers that could be either a natural or synthetic material or any combination thereof, for example, nonwoven webs, woven webs, knitted fabrics, and any combinations thereof.

The term “substrate” as used herein refers to a material that includes either a natural or synthetic material or any combination thereof, for example, nonwoven webs, woven webs, knitted fabrics, films, film laminates, nonwoven laminates, sponges, foams, and any combinations thereof.

The term “nonwoven” as used herein refers to a material made from continuous and/or discontinuous fibers, without weaving or knitting, by processes such as spun-bonding, carding and melt-blowing. The nonwoven webs can comprise one or more nonwoven layers, wherein each layer can include continuous and/or discontinuous fibers. Nonwoven webs can also comprise bicomponent fibers, which can have shell/core, side-by-side, or other known fiber structures.

The term “elastic” or “elastomeric” as used herein refers to any material that upon application of a biasing force, can stretch to an elongated length of at least about 160 percent of its relaxed, original length, without rupture or breakage, and upon release of the applied force, recovers at least about 55% of its elongation, preferably recovers substantially to its original length that is, the recovered length being less than about 120 percent, preferably less than about 110 percent, more preferably less than about 105 percent of the relaxed original length.

The term “inelastic” refers herein to any material that does not fall within the definition of “elastic” above.

The term “elastomer” as used herein refers to a polymer exhibiting elastic properties.

The term “extensible” or “inelastically elongatable” refers herein to any material that upon application of a biasing force to stretch beyond about 110 percent of its relaxed original length will exhibit permanent deformation, including elongation, rupture, breakage, and other defects in its structure, and/or changes in its tensile properties.

The term “necked material” refers to any material that has been narrowed in one direction by the application of a tensioning force.

The stretch composite made by the process of the present invention comprises one or more elastomeric members disposed on and at least in some locations partially penetrating a portion of an extensible substrate, which is permanently elongated in the finished composite. Different elastomeric members can be disposed on spaced-apart, adjacent or overlapping portions of the substrate to deliver different properties, especially different elasticity. The stretch composite can be made in situ as a portion of an article by the present process to form a desired article having a stretch laminate therein. The in-situ process eliminates additional processing steps, such as cutting, shaping, and bonding. In the process of the present invention, the expensive elastomeric material is used efficiently by delivering one or more elastomeric members to the article only where they are needed and in the amount needed. Further, the resulting product made with the laminate and the process disclosed herein can provide improved product fit and comfort.

An embodiment of the resulting stretch composite contains a first extensible substrate having one or more first elastomeric members in a first elasticized region that may be converted to from one or more elastomeric compositions having a melt viscosity of from about 1 to about 400 Pa#s, measured at 175° C. and 1 s⁻¹ strain rate and having an elasticity of at least about 50 N/m and a force relaxation of less than about 20%; at least a portion of the first elasticized region is incrementally stretched, resulting in permanent elongation of the substrate in said portion of the first elasticized region. The stretch composite may further contain one or more elastomeric members in a second elasticized region that may be converted to from one or more elastomeric compositions having a melt viscosity of from about 1 to about 400 Pa#s, measured at 175° C. and 1 s⁻¹ strain rate and the second elastomeric members exhibit an elasticity of at least about 50 N/m and a force relaxation of less than about 20%; at least a portion of the second elasticized region has been incrementally stretched, resulting in permanent elongation of the substrate in said portion of the second elasticized region. Optionally, the stretch composite may contain a second extensible substrate joined to the first substrate in a facing relationship such that the above elastomeric members are sandwiched between the substrates.

The stretch composite may be used for portions of an absorbent article to provide desired benefits including better fit, improved comfort, lower forces to put on and/or take off the article. Stretchability is desirable in portions of the absorbent article that typically include, but are not limited to, the waist regions, the leg cuffs, side panels, ear portions, topsheet, outercover and the fastener system.

The elastomeric members can have varied shapes and profiles in any direction, which result in desired variations in physical properties of the composite material within the elastomeric members. The planar shape in the x-y direction of the elastomeric members can be any suitable geometrical shape defining the planar dimensions of the composite material, including a rectilinear outline, a curvilinear outline, a triangle, a trapezoid, a square, a parallelogram, a polygon, an ellipse, a circle, and any combination thereof. The contour profile in the z direction of the elastomeric members can be any suitable geometric shape including linear and nonlinear profiles. The variation in the dimension in the z direction and the x-y plane can be achieved by the process of the present invention. Typically, the average width of an individual elastomeric member is from about 0.2 mm to about 7 mm. In some embodiments, the average width of an individual elastomeric member is preferably greater than about 0.2 mm, more preferably greater than about 1 mm, and most preferably greater than about 2 mm. The average thickness of individual elastomeric member is from about 0.1 mm to about 2.5 mm, preferably from about 0.25 mm to about 2 mm, and more preferably from about 0.5 mm to about 1.5 mm. The average width and thickness of the elastomeric members can be determined by conventional optical microscopy or by scanning electron microscopy (according to ASTM B748) for more precise measurements. For some embodiments, the thickness of the elastomeric member and/or the composite can be measured under a pressure of 0.25 psi (1.7 Kpa) using a microcaliper.

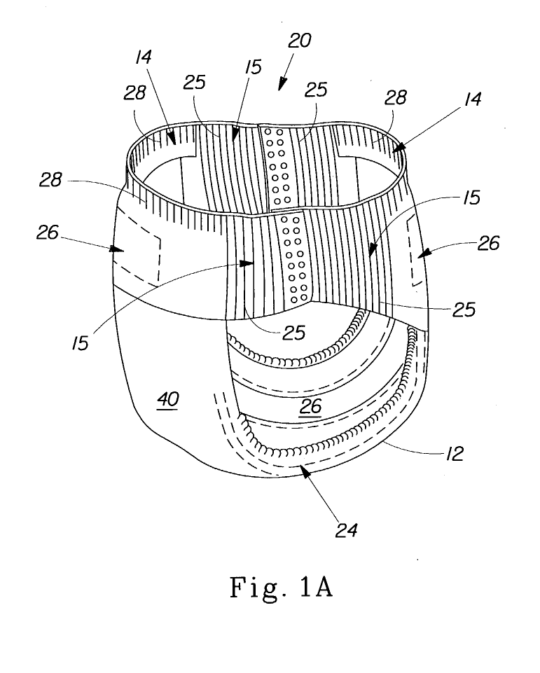

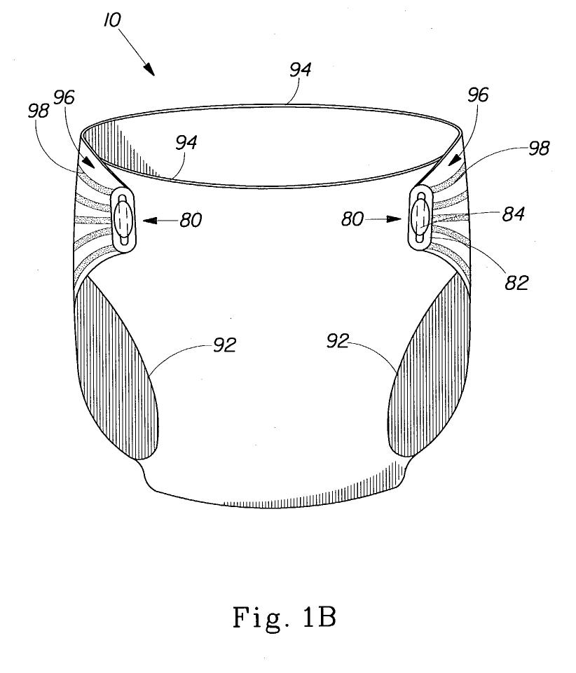

FIG. 1A illustrates one embodiment of an absorbent article (a pant type diaper) in an in-use configuration, wherein at least a portion of the article comprises the stretch laminate of the present invention. Pant type diaper 20 may comprise a plurality of elastic components on a substrate, typically a nonwoven fibrous web, to provide specific functions for the diaper. The elastic components include elasticized cuff region 12 comprising leg elastomeric members 24 that provide a gasketing function around the legs of the wearer; elasticized waist region 14 comprising waist elastomeric members 28 that provide a gasketing function around the waist; elasticized side panel 15 comprising panel elastomeric members 25 that provide an adjustable fit function around the lower torso; and outer cover 40 comprising chassis elastomeric members 26 that provide an adjustable fit function directed mainly to tummy, buttocks and/or the crotch areas. The chassis elastomeric members 26 may also be used to adjust the breathability (i.e., substantially vapor/gas permeable and liquid impermeable) of the outer cover 40. Another embodiment, shown in FIG. 1B in an in-use configuration, is a disposable diaper 10 having elastic leg openings 92, elastic waist opening 94, elastic ear portion 96 comprising elastic ear members 98, and the fastener system 80 comprising a slot member 82 and a tab member 84, all of which can be made of the stretch composites of the present invention. An elasticated topsheet (not shown) can also be made of the composite of the present invention.

Traditionally, the manufacture of these elastic components of a diaper includes the steps of cutting an elastomeric material (in the form of a film, a fibrous web, or a laminate) to the desired size and shape, then joining the discrete pieces of elastomeric materials to the substrate using known bonding methods such as adhesive, thermal, mechanical, ultrasonic bonding. In contrast, the present invention provides a novel process that combines the step of making of an elastomeric component and the step of joining the elastomeric component to a substrate into a single step continuous process. A given elastic component may comprise a single elastomeric member or a plurality of elastomeric members. These elastomeric members could be same or different in terms of shape, dimensions, composition, etc. Moreover, in the present invention, the elastomeric members may be converted from elastomeric compositions, which can be applied directly onto multiple portions, corresponding to discrete elastic components of the diaper to form the waist elastomeric members, leg elastomeric members, etc., in one continuous process. The present invention is well suited to deliver different elasticities to meet the different requirements of individual components of the diaper. It is also contemplated by the present invention that multiple elastomeric members having different elasticities may be applied in adjacent portions on a single element of an absorbent article. The different elasticities may be achieved by variations in melt viscosities, shapes, patterns, add-on levels, compositions, and combinations thereof.

The elastomeric compositions may be applied to a substrate continuously or intermittently to form elastomeric members of various shapes or patterns. Typical shapes of the elastomeric members include stripes (rectilinear or curvilinear), spirals, discrete dots and the like. The elastomeric members may also be formed into various geometric or decorative shapes or figures. The various patterns may place the elastomeric members in perpendicular, parallel and/or angled (i.e., non-parallel) positions with respect to one another, or with respect to components of the diaper, such as a waist opening, leg openings, and/or side seams. Two elastomeric members are parallel when they exhibit substantially uniform inter-member or lateral spacing. They are non-parallel when they exhibit non-uniform inter-member or lateral spacing. Thus, two curvilinear elastomeric members are non-parallel if they have different curvatures (see, for example, elastic members 98 in FIG. 1B). In another example, an elastomeric member is parallel to a waist region or a leg opening when the spacing between the elastomeric member and an edge of the waist region or a leg opening is substantially uniform. A crosshatch pattern is formed when non-parallel elastomeric members intersect. Such a pattern can be formed with a single printing unit.

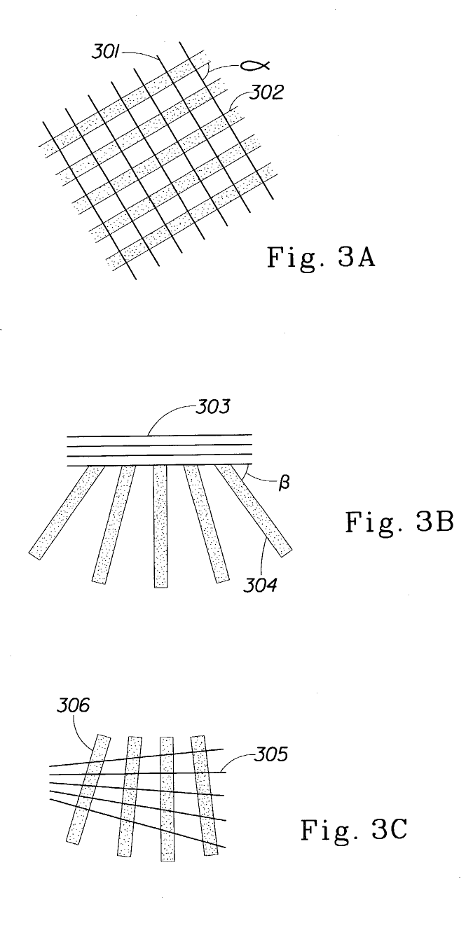

More than one printing unit will be needed for printing two or more different elastomeric compositions. In one embodiment, as shown in FIG. 3A, one or more first elastomeric compositions are applied in a substantially parallel pattern along a first direction to form a plurality of first elastomeric members 301 in the form of rectilinear stripes. Optionally, one or more second elastomeric compositions that are the same or different from the first elastomeric compositions are applied in a substantially parallel pattern along a second direction to form a plurality of second elastomeric members 302 in the form of rectilinear stripes, the second direction being at a predetermined angle α with respect to the first direction. The predetermined angle α ranges from about zero to about 90 degrees, preferably from about 1 to about 80 degrees, and more preferably from about 5 to about 70 degrees. The first and the second elastomeric compositions can be deposited on fully or partially overlapping portions (corresponding to the same or partially overlapping elastic components of the finished diaper) of the substrate. Alternatively, the first and second elastomeric compositions can be deposited on non-overlapping (adjacent or remote) portions of the substrate, which correspond to distinct elastic components of the finished diaper. Consequently, the resulting first and second elastomeric members do not cross over.

In other embodiments, a first elastomeric composition is applied in a substantially parallel pattern along a first direction to form a plurality of first elastomeric members in the form of rectilinear stripes, and a second elastomeric composition is applied in a non-parallel or angled pattern along a second direction to form a plurality of second elastomeric members in the form of rectilinear stripes, wherein at least one, preferably a plurality, of the stripes of the second elastomeric members are angled or non-parallel to one or both adjacent stripes of the same elastomeric members. The first and second elastomeric compositions may be deposited on the same, overlapping or separate portions of the fibrous substrate. FIG. 3B illustrates one of the above embodiments wherein the first elastomeric members are substantially parallel and rectilinear stripes 303 along a first direction and the second elastomeric members are rectilinear stripes 304 which are not parallel to adjacent stripes 304; each stripe of the second elastomeric members forms a predetermined angle β with respect to the first direction. Specifically, the predetermined angle β ranges from about zero to about 180 degrees and varies among different stripes 304. Alternatively, the first and second elastomeric members are in a non-parallel or angled pattern, and forming varying angles between the stripes 305, 306, such as the embodiment shown in FIG. 3C.

The substrate material may be films, knitted fabric, woven fibrous webs or nonwoven fibrous webs, or combinations thereof. In some embodiments, the substrates are extensible nonwoven webs made of polyolefin fibers or filaments, such as polyethylene, polypropylene, etc. The substrate can also be a nonwoven-film laminate, for example the outercover of a disposable diaper.

Suitable elastomeric compositions are applied to the substrate in a fluid or fluid-like state to effect partial penetration into the substrate at least in some locations, thus, bonding between the resulting elastomeric members and the substrate can be achieved in a single step. The elastomeric composition may have a melt viscosity from about 1 to about 400 Pa#s, preferably from about 5 to about 300 Pa#s, more preferably from about 10 to about 250 Pa#s, and most preferably from about 25 to about 200 Pa#s at 175° C. and 1 s⁻¹ strain rate. Such elastomeric compositions are suitable for use in processes that operate at a lower viscosity and/or lower temperature than the processing conditions of a typical melt extrusion and/or fiber spinning process.

The elastomeric compositions have the following properties: (1) an elasticity (i.e., normalized load at 75% strain) of at least about 50 N/m, preferably from about 50 N/m to about 300 N/m, more preferably from about 75 N/m to about 250 N/m, and most preferably from 100 N/m to about 200 N/m; (2) a percent set of less than about 20%, preferably less than about 15% and more preferably less than about 10%; and (3) a force relaxation value of less than about 20%, preferably less than about 15%, and more preferably less than about 10%.

Suitable elastomeric compositions comprise thermoplastic elastomers selected from the group consisting of styrenic block copolymers, metallocene-catalyzed polyolefins, polyesters, polyurethanes, polyether amides, and combinations thereof. Suitable styrenic block copolymers may be diblock, triblock, tetrablock, or other multi-block copolymers having at least one styrenic block. Exemplary styrenic block copolymers include styrene-butadiene-styrene, styrene-isoprene-styrene, styrene-ethylene/butylene-styrene, styrene-ethylene/propylene-styrene, and the like. Commercially available styrenic block copolymers include KRATON® from the Shell Chemical Company of Houston, Tex.; SEPTON® from Kuraray America, Inc. of New York, N.Y.; and VECTOR® from Dexco Chemical Company of Houston, Tex. Commercially available metallocene-catalyzed polyolefins include EXXPOL® and EXACT® from Exxon Chemical Company of Baytown, Tex.; AFFINITY® and ENGAGE® from Dow Chemical Company of Midland, Mich. Commercially available polyurethanes include ESTANE®) from Noveon, Inc., Cleveland, Ohio. Commercial available polyether amides include PEBAX® from Atofina Chemicals of Philadelphia, Pa. Commercially available polyesters include HYTREL® from E. I. DuPont de Nemours Co., of Wilmington, Del.

The elastomeric compositions may further comprise processing aids and/or processing oils to adjust the melt viscosity of the compositions. They include the conventional processing oil, such as mineral oil, as well as other petroleum-derived oils and waxes, such as paraffinic oil, naphthenic oil, petrolatum, microcrystalline wax, paraffin or isoparaffin wax. Synthetic waxes, such as Fischer-Tropsch wax; natural waxes, such as spermaceti, carnauba, ozokerite, beeswax, candelilla, ceresin, esparto, ouricuri, rezowax, and other known mined and mineral waxes, are also suitable for use herein. Olefinic or diene oligomers and low molecular weight resins may also be used herein. The oligomers may be polypropylenes, polybutylenes, hydrogenated isoprenes, hydrogenated butadienes, or the like, with a weight average molecular weight between about 350 and about 8000.

In one embodiment, a phase change solvent is used as the processing aid. It can be incorporated into the elastomeric composition to lower the melt viscosity, rendering the composition processable at a temperature of 175° C. or lower, without substantially compromising the elastic and mechanical properties of the composition. Typically, the phase change solvent exhibits a phase change at temperatures ranging from about 40° C. to about 250° C. The phase change solvent has the general formula:

R′-L_{y}-(Q-Lₓ)ₙ₋₁-Q-L_{y}-R; (I)

R′-L_{y}-(Q-Lₓ)ₙ-R; (II)

R′-(Q-Lₓ)ₙ-R; (III)

R′-(Q-Lₓ)ₙ₋₁-Q-L_{y}-R; (IV)

R′-(Q-Lₓ)ₙ₋₁-Q-R; or (V)

a mixture thereof;

wherein Q may be a substituted or unsubstituted difunctional aromatic moiety; L is CH₂; R and R′ are the same or different and are independently selected from H, CH3, COOH, CONHR₁, CONR₁R₂, NHR₃, NR₃R₄, hydroxy, or C1-C30 alkoxy; wherein R₁, R₂, R₃ and R₄ are the same or different and are independently selected from H or linear or branched alkyl from C1-C30; x is an integer from 1 to 30; y is an integer from 1 to 30; and n is an integer from 1 to 7. Detailed disclosure of the phase change solvents can be found in Provisional U. S. Patent Application Ser. No. 60/400,282, filed on Jul. 3, 2002. In some embodiments, the weight ratio of thermoplastic elastomer to processing oil or processing aid (e.g., a phase change solvent) in the elastomeric composition typically ranges from about 10:1 to about 1:2, preferably from about 5:1 to about 1:1, and more preferably about 2:1 to about 1:1.

Alternatively, the elastomeric composition may also comprise low molecular weight elastomers and/or elastomeric precursors of the above thermoplastic elastomers, and optional crosslinkers, or combinations thereof. The weight average molecular weight of the low molecular weight elastomers or elastomeric precursors is between about 45,000 and about 150,000. In some embodiments, the weight ratio between thermoplastic elastomer to low molecular weight elastomers or elastomeric precursors to the thermoplastic elastomers in the composition typically ranges from about 10:1 to about 1:2, preferably from about 5:1 to about 1:1, and more preferably about 2:1 to about 1:1.

Suitable elastomeric compositions for use herein will form elastomeric members that are elastic without further treatment and these elastomeric compositions do not include any volatile solvents with boiling point below 150° C. After the elastomeric composition has been applied to the substrate, however, post-treatments may be used to improve or enhance the elasticity and other properties including strength, modulus, and the like of the resulting elastomeric members. Typically, post-treatments converting the elastomeric compositions into elastomeric members by methods such as cooling, crosslinking, curing via chemical, thermal, radiation means, pressing between nip rolls, and combinations thereof.

The elastomeric members may be applied to a specific region of a substrate to achieve a total add-on level of from about 5 to about 200 g/m², preferably from about 20 to about 150 g/m², and more preferably from about 50 to about 100 g/m². The first and the second elasticized regions may have open areas not covered by elastomeric members ranging from about 10% to about 80% of the total surface area of the region, preferably from about 20% to about 70%, and more preferably from about 40% to about 60%. Selective deposition of elastomeric compositions uses a smaller amount of the elastomers than the amount that would be required by the conventional lamination technology using films or sheets. The extensible substrate with selectively deposited elastomeric members can provide the resulting composite with a lower basis weight and a higher breathability than those of a laminate containing a fibrous web layer and an elastic film layer. In the absence of a film layer, the extensible substrate is better able to provide a soft, cloth-like feel to the skin for wearer comfort.

Each elasticized region may have a different number of elastomeric members disposed per unit area. The add-on level per elastomeric member can differ from region to region. Thus, when comparing a first elasticized region having first elastomeric members disposed thereon and a second elasticized region having second elastomeric members disposed thereon, the weight ratio of the add-on level on the basis of individual first and second elastomeric member, may range from about 1.05 to about 3, preferably from about 1.2 to about 2.5, and more preferably from about 1.5 to about 2.2. Further, the first and the second elastomeric members may have an elasticity ratio of from about 1.1 to about 10, preferably from about 1.2 to about 5, and more preferably from about 1.5 to about 3.

The elastomeric compositions may be printed directly on the substrate, or indirectly transferred to the substrate by first being deposited onto an intermediate surface. Suitable printing methods include contact methods such as gravure printing, intaglio printing, flexographic printing, and the like. Each application method operates in a specific viscosity range, thus, suitable elastomeric composition has a viscosity within that range. Composition, temperature and/or concentration can be varied to provide the suitable viscosity for a given processing method and operating conditions.

Temperature may be raised to lower the viscosity of the elastomeric composition. High temperatures, however, may have an adverse effect on the stability of the substrate, which may experience partial or local thermal degradation where the heated elastomeric composition is deposited. A balance between these two effects is desirable. Alternatively, indirect/transfer methods may be used. The elastomeric composition is heated to achieve a suitable viscosity for processing and applied to an intermediate surface (e.g., a transfer roll or a carrier substrate) having good thermal stability, which is then transferred to the substrate. The indirect/transfer method allows for a wider range of operating temperatures because the fluid or fluid-like elastomeric composition is partially cooled when it contacts the substrate. Thus, the indirect process may be useful for substrates that are thermally sensitive or unstable, such as nonwoven webs, or substrates of low melting polymers, including polyethylene and polypropylene. Preferably, as the elastomeric composition is being transferred from the carrier surface to the substrate, it is still in a fluid phase or has sufficient flowability to at least partially penetrate the substrate at least at some locations. Additionally, nip pressure may be applied via nip rolls or calendar rolls to enhance penetration and bonding.

It is desirable to have the elastomeric composition at least partially penetrate the substrate at least in some locations, so that the resulting intermediate structure does not delaminate in the subsequent processing or manufacturing steps or in the finished product. Additionally, such good bonding within the composite and/or its preform renders the use of adhesives optional. The degree of penetration may be affected by several factors: the viscosity of the elastomeric composition when in contact with the substrate, the porosity of the substrate, and the surface tension between the substrate and the elastomeric composition. In one embodiment, the off-set gravure printing process allows partial cooling of the elastomeric composition before it contacts the substrate, and thus increases its viscosity and decreases the degree of penetration into the substrate. Alternatively, the elastomeric composition may be cooled by blowing chilled air/gas onto it prior to or while coming into contact with the substrate. In another embodiment, the degree of penetration may be enhanced by passing the substrate/elastomeric composition through a pair of nip rolls. The temperature of the nip rolls as well as the applied nip pressure provide further control of the degree of penetration. In some case, it may be desirable to enhance penetration only in some areas of contact between the fibrous web and the elastomeric materials. This can be accomplished with the use of a patterned, instead of smooth, backup roll during printing. For example, the backup roll can have longitudinal (MD) grooves.

In another embodiment, the gravure printing method is used, whereby it is possible to vary the amount of elastomeric composition deposited in different portions of the substrate, thereby varying the local stretch properties. For example, by incorporating different depth and/or width of grooves and lands on the gravure roll, the resulting elastomeric members can be thicker in one area and thinner in another area. In another example, by changing the pattern on the gravure roll, the resulting elastomeric members can exhibit varying member densities (i.e., numbers of elastomeric members per unit area) from one area to another area of the composite. Furthermore, two or more gravure rolls, with different elastomeric compositions in each, can also be used to deposit these elastomeric compositions in different portions of the substrate.

Furthermore, it is also possible to combine different deposition processes, for example gravure printing with spraying or flexo printing, to obtain the desired properties in the resulting stretch composites.

The stretch property can be varied discretely, that is, the property changes in a stepwise manner. An example of such stepwise change would be to apply a high performance elastomer in one portion of an element (such as the top part of an ear portion of a diaper) and a lower performance elastomer in another portion of that element (such as the lower part of the ear portion) where the stretch requirements are less demanding. The stretch property can also be varied continuously, either linearly or non-linearly. The continuous changes in stretch property may be achieved by a gravure pattern designed in such a way that the groove depth decreases gradually along the length of the groove, thus resulting in a printed pattern where the amount of deposited elastomeric composition decreases continuously from one end of the elastic member to the other.

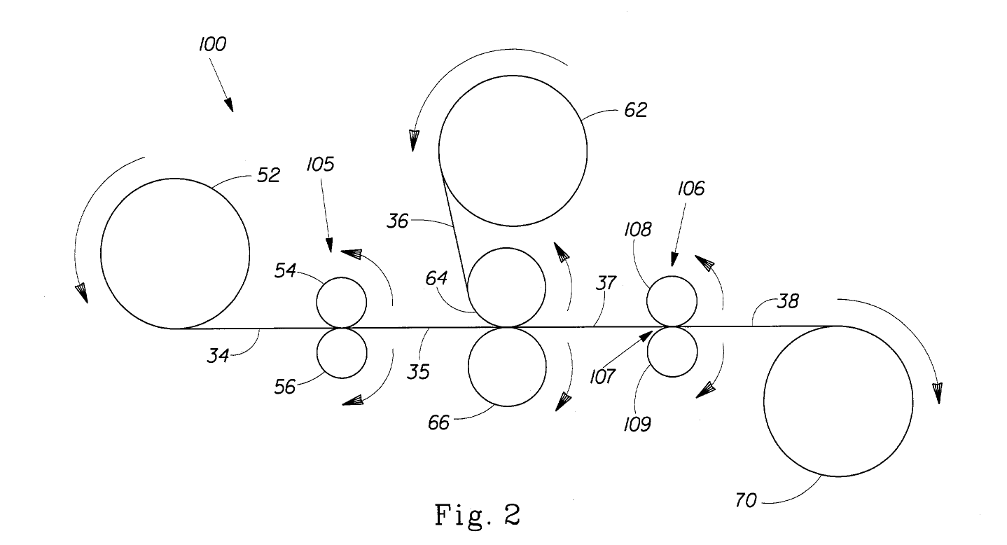

The stretch composite can be manufactured by process 100 of the present invention, one embodiment of which is illustrated schematically in FIG. 2. Process 100 may include a primary operation of making an intermediate structure, which includes the steps of supplying a first substrate; applying an elastomeric composition or material to the first extensible substrate; and optionally joining with a second substrate. Process 100 includes a secondary operation of incrementally stretching the intermediate structure to provide extensibility to the substrate.

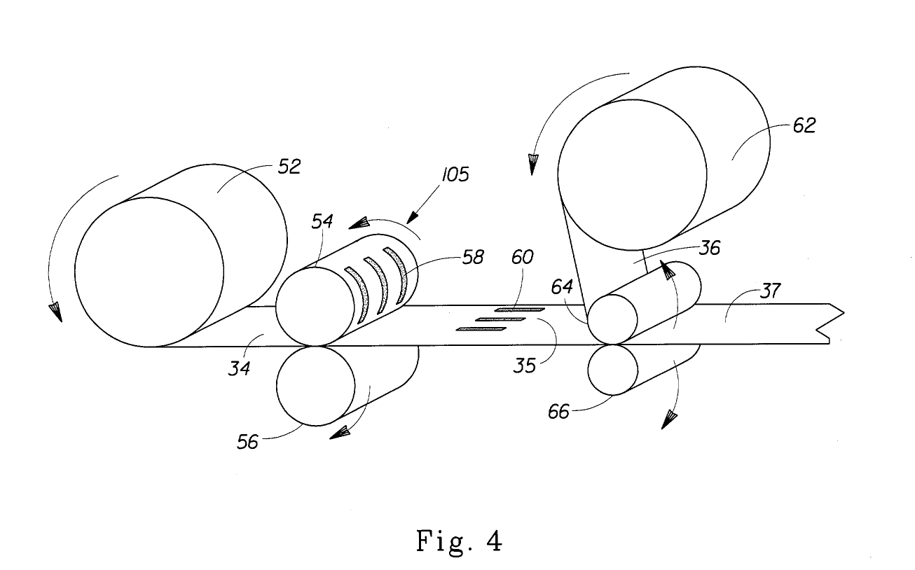

The primary operation of process 100 is shown in detail in FIG. 4. The first extensible substrate 34 is provided by a first supply roll 52 and moves through an application device 105, which is a rotogravure printing device comprising a gravure printing roll 54 and a back-up roll 56, that deposits the elastomeric composition for elastomeric members onto substrate 34. The elastomeric composition, being in a fluid or fluid-like state, may at least partially penetrate substrate 34 to provide a printed substrate 35, resulting in direct bonding between the elastomeric members and the substrate. Optionally, a second substrate 36 may be provided by a second supply roll 62 and combined with the printed substrate 35 via nip rolls 64, 66 to sandwich the elastomeric members between substrates 34, 36 to form an intermediate structure 37. If necessary, adhesives may be used to bond the two substrates. At this point of the process, a zero strain laminate is produced wherein the elastomeric members and the substrates are bonded in an unstrained state.

The printed substrate 35 and/or the intermediate structure 37 may be subjected to additional treatments such as cooling, pressing (e.g., passing between a pair of nip rolls), crosslinking, curing (e.g., via chemical, thermal, radiation methods), and combinations thereof, to enhance the elastic and mechanical properties of the elastomeric composition deposited thereon and of the resulting intermediate structure.

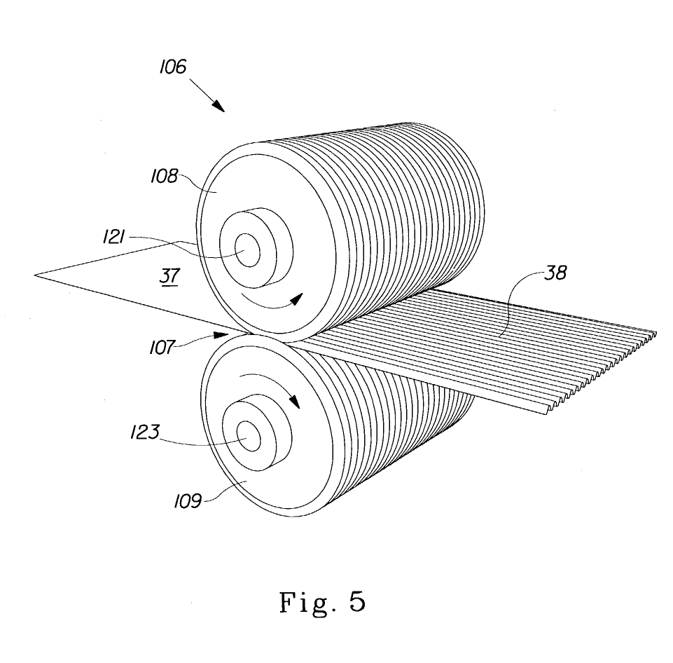

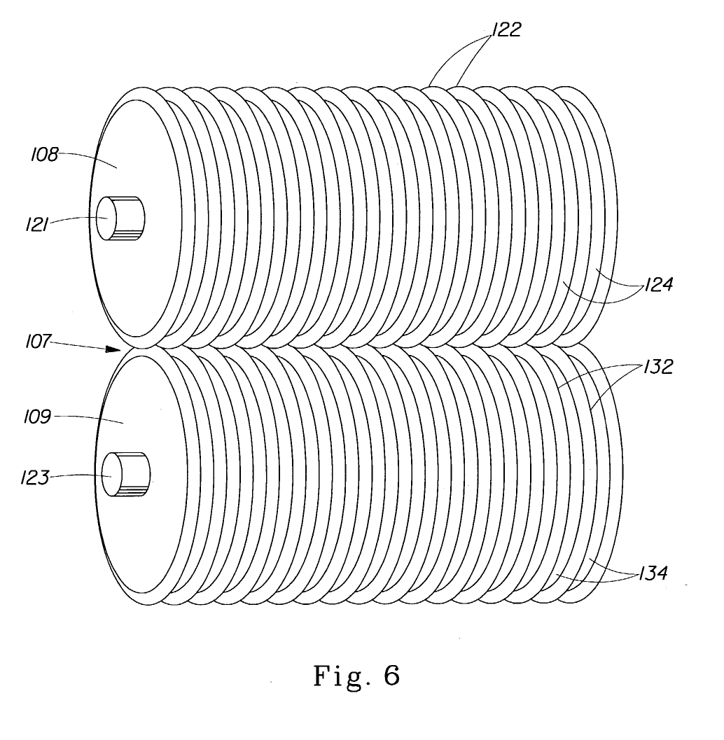

A secondary operation of process 100 is shown in FIG. 5. This secondary operation uses forming station 106 to incrementally stretch the intermediate structure 37 to the extent that the, substrate is permanently elongated and intermediate structure 37 is converted into stretch composite 108. Due to this structural change, the substrate has a reduced resistance to stretch and the elastomeric members are able to stretch to the extent provided by the permanent elongation of the substrate.

A process sometimes referred to as “ring-rolling,” may be a desirable incremental stretching operation of the present invention. In the ring rolling process, corrugated interengaging rolls are used to permanently elongate the substrate to reduce its resistance to stretch. The resulting composite has a greater degree of stretchability in the portions that have been subjected to the ring rolling process. Thus, this secondary operation provides additional flexibility in achieving stretch properties in localized portions of the stretch composite.

Methods for imparting stretchability to an extensible or otherwise substantially inelastic material by using corrugated interengaging rolls which incrementally stretch in the machine or cross-machine direction and permanently deform the material are disclosed in U.S. Pat. No. 4,116,892, issued on Sep. 26, 1978, to E. C. A. Schwarz; U.S. Pat. No. 4,834,741, issued on May 30, 1989, to R. N. Sabee; U.S. Pat. No. 5,143,679, issued on Sep. 1, 1992 to G. M. Weber et al.; U.S. Pat. No. 5,156,793, issued on Oct. 20, 1992, to K. B. Buell et al.; U.S. Pat. No. 5,167,897, issued on Dec. 1, 1992 to G. M. Webber et al.; and U.S. Pat. No. 5,422,172, issued on Jun. 6, 1995, to P. C. Wu; and U.S. Pat. No. 5,518,801, issued on May 21, 1996 to C. W. Chappell et al. In some embodiments, the intermediate structure may be fed into the corrugated interengaging rolls at an angle with respect to the machine direction of this secondary operation. Alternatively, the secondary operation may employ a pair of interengaging grooved plates applied to the intermediate structure under pressure to achieve incremental stretching of the intermediate structure in localized portions.

Extensibility may also be imparted to the substrate via necking as described in U.S. Pat. Nos. 5,226,992 and 5,910,224, both assigned to Kimberly-Clark Worldwide, Inc. In this process, the substrate is necked in one direction by applying tension, and the elastomer is printed while the substrate is still in the necked state. If necessary, this laminate can be incrementally stretched to further enhance the stretch properties. Another method of imparting extensibility is by consolidation as described in U.S. Pat. Nos. 5,914,084 and 6,114,263, both assigned to The Procter & Gamble Company. As described, consolidation involves feeding a neckable nonwoven in a first direction, subjecting the nonwoven to incremental stretching in a direction perpendicular to the first, applying a tensioning force to the nonwoven to neck the nonwoven, subjecting the nonwoven to mechanical stabilization to provide a stabilized, extensible, necked nonwoven. Additionally, the requisite incremental stretching may be achieved by a combination of the stretching techniques detailed herein. As with necking, this laminate can optionally be incrementally stretched to further enhance stretch properties.

It is desirable that the extensible substrate does not exhibit resistance to stretch when the composite is subjected to a typical strain under the in-use condition. The in-use strains experienced by the composite are due to the stretching when the article is applied to or removed from a wearer and when the article is being worn. The extensible substrate can be pre-strained to impart the desired stretchability to the composite. Typically, when the extensible substrate is pre-strained to about 1.5 times of the maximum in-use strain (typically less than about 250% strain), the extensible substrate becomes permanently elongated such that it does not exhibit resistance to stretch within the range of in-use strain and the elastic properties of the composite is substantially the same as the sum of the elastomeric members in the composite.

The stretch composite may have a directional elasticity in at least one direction of no more than about 400 N/m, preferably from about 5 N/m to about 400 N/m, more preferably from about 25 N/m to about 300 N/m, and most preferably from about 75 N/m to about 200 N/m, when measured as load at 75% strain. Additionally, the resulting stretch composite has the following properties: a directional percent set in at least one direction of less than about 20%, preferably less than about 15% and more preferably less than about 10%; and a directional force relaxation value in at least one direction of less than about 30%, preferably less than about 22%, and more preferably less than about 15%.

In one embodiment, as shown in FIG. 2, the ring rolling process is incorporated into process 100 as a secondary operation, which includes a forming station 106 positioned between application device 105 and take-up roll 70. Alternatively, if a second substrate 36 is included, the forming station 106 may be positioned between the second supply roll 62 and the take-up roll 46. Referring to FIG. 5, intermediate structure 37 is fed to the nip 107 formed by a pair of opposed forming rolls 108 and 109 that together define a forming station 106. Forming station 106 incrementally stretches and permanently elongates the substrate, thereby intermediate structure 37 is converted into stretch composite 38.

Exemplary structures and relative positions of forming rolls 108, 109 are shown in an enlarged perspective view in FIG. 6. As shown, rolls 108 and 109 are carried on respective rotatable shafts 121, 123, having their axes of rotation disposed in parallel relationship. Each of rolls 108 and 109 includes a plurality of axially-spaced, side-by-side, circumferentially-extending, equally-configured teeth 122 and 132, respectively, that can be in the form of thin fins of substantially rectangular cross section, or they can have a triangular or an inverted V-shape when viewed in cross section. The outermost tips of the teeth are preferably rounded to avoid cuts or tears in the materials that pass between the rolls.

The spaces between adjacent teeth 122, 132 define recessed, circumferentially-extending, equally configured grooves 124, 134, respectively. The grooves can be of substantially rectangular cross section when the teeth are of substantially rectangular cross section, and they can be of inverted triangular cross section when the teeth are of triangular cross section. Thus, each of forming rolls 108 and 109 includes a plurality of spaced teeth 122, 132 and alternating grooves 124, 134 between each pair of adjacent teeth. The teeth and the grooves need not each be of the same width, however, and preferably the grooves have a larger width than that of the teeth, to permit the material that passes between the interengaged rolls to be received within the respective grooves and to be locally stretched, as will be explained hereinafter.

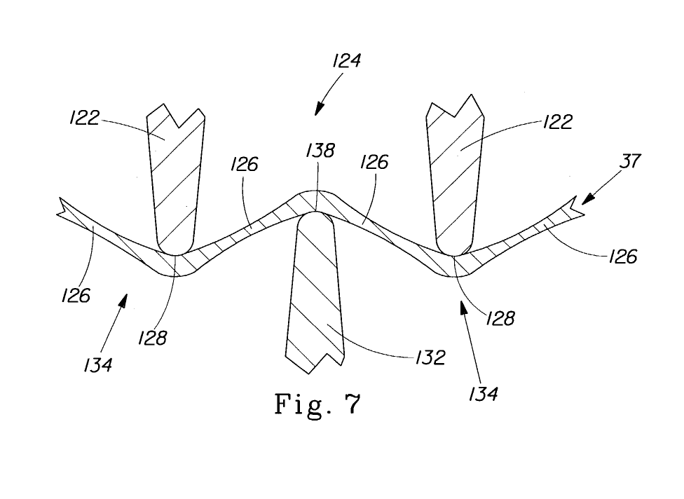

FIG. 7 is an enlarged cross-sectional view of interengaged teeth 122, 132 and grooves 124, 134 with an intermediate structure being modified therebetween. As shown, a portion of intermediate structure 37 is received between the interengaged teeth and grooves of the respective rolls. The interengagement of the teeth and grooves of the rolls causes laterally spaced portions of intermediate structure 37 to be pressed by teeth 122, 132 into opposed grooves 134, 124. In the course of passing between the forming rolls, the forces of teeth 122, 132 pressing intermediate structure 37 into opposed grooves 134, 124 impose within intermediate structure 37 tensile stresses that act in the cross-web direction. The tensile stresses cause intermediate portions 126 that lie between and span the spaces between the tip portions 128, 138 of adjacent teeth 122, 132 to stretch or extend in a cross-web direction, which results in a localized reduction of the web thickness as well as web tensile strength at each of intermediate portions 126.

The action of pressing of portions of intermediate structure 37 into the respective grooves 124, 134 by teeth 132, 122 causes a non-uniform reduction of the thickness of intermediate structure 37 to take place in the cross-web direction of the composite. The thickness of portions that are in contact with the tooth tips reduce only slightly compared to the thickness reduction of intermediate portions 126 that span adjacent teeth 122, 132. Thus, by passing through the interengaged rolls and being locally laterally stretched at spaced intervals between adjacent teeth, the inelastic elongatable or extensible web develops alternating high and low basis weight regions. The low basis weight regions are found at the positions of the web that have been locally laterally stretched. Additional cross-web stretching of the exiting, formed web can be effected by passing the modified web between so-called Mount Hope rolls, tentering frames, angled idlers, angled nips, and the like, each of which is known to those skilled in the art.

Alternatively, other process embodiments of the present invention can include the use of multiple deposition devices to provide multiple depositions of elastomeric compositions or materials onto one or more substrates, including deposition onto two substrates separately and then combining them, and/or making several subsequent depositions onto the same substrate. Further, the use of multiple deposition devices can provide a greater deposition weight of the elastomeric material, a greater variation in thickness profile, capability to deposit different elastomeric materials, and capability to deposit elastomeric materials of different colors, and any combinations thereof.

In one embodiment, the outer cover 40 of a pant type diaper 20 shown in FIG. 1A may include chassis elastomeric members 26 to vary breathability of the outer cover 40 while maintaining liquid impermeability of the outer cover 40. Chassis elastomeric members 26 may be disposed on either side of the outer cover 40 in the tummy region, the buttocks region or the crotch region. Multiple chassis elastomeric members 26 may be disposed on the outer cover 40 with various orientations. For example, multiple chassis elastomeric members 26 may be disposed parallel to, perpendicular to, or at an angle to the waist region or the leg openings, and each elastomeric member may have different orientation from neighboring elastomeric members.

Test Methods

Melt Viscosity Test

The melt viscosity of elastomeric compositions that comprise the elastomeric members can be measured using the RDA II Viscometer (manufactured by Rheometrics) or the AR 1000 Viscometer (manufactured by TA Instruments) in the parallel plate mode or comparable instrumentation. Calibration, sample handling and operation of the instrument follow the manufacturer's operating manual. Testing conditions used specifically for this test are disclosed herein. In this test, the sample of the elastomeric composition is placed between two parallel plates that are 25 mm in diameter and have a gap of 1.5 mm between them. The sample chamber is heated to and maintained at 175° C. Melt viscosity is measured under the steady state condition at shear rate of 1 s⁻¹ and an oscillation of 5% strain.

Hysteresis Test for Elastic Properties

(i) Sample Preparation for Elastomeric Members

The properties of the elastomeric members are obtained by using test samples cut from cast films of the approximate size of 4″ by 4″ (101.6 mm by 101.6 mm). Shims of 0.010″ (0.254 mm) thickness are used to define the borders of the case film and to control film thickness. About 5 grams of the elastomeric composition is spread evenly inside the borders and sandwiched between two silicone-coated release films, which are large enough to fully cover the cast film. This set-up is heated to about 150 to 200° C. and pressed in a Carver hand press under sufficient pressure, typically 5-10 psi (3.5-6.9×10³ N/m²) for one minute to consolidate the elastomeric composition. Then, the pressure is released and the film is allowed to cool down. Depending on the type of elastomeric composition being cast, temperatures and pressures can be adjusted accordingly. Test samples of specific sizes for a given test and /or instrument are cut and trimmed from the cast film. For example, samples used herein are 1″ by 3″ (25.4 mm by 76.2 mm). All surfaces of the sample should be free of visible flaws, holes, scratches or imperfections.

(ii) Sample Preparation for Composite

Samples of 1″ by 3″ (25.4 mm by 76.2 mm) size are obtained from the elasticized region of the composite. It is recognized that the stretch composite may exhibit directional properties that are not the same when the composite is measured in different directions, depending on the orientation of the elastomeric members within the sample. Therefore, samples from a given elasticized region are prepared with four different orientations in order to obtain representative directional properties of the composite. Specifically, the samples are obtained from a given elasticized region with its longitudinal axis aligned in a first direction, a second direction which is perpendicular to the first direction, and a third and a fourth directions which are ±45° with respect to the first direction. The first direction may be, but is not required to be, the machine direction (i.e., the substrate movement direction during the process of applying the elastomeric members to the substrate). At least three samples along each orientation are prepared. Where the composite is substantially homogenous to the naked eye, these directional samples can be taken from neighboring elasticized regions. Where the composite is visibly not homogenous from one region to another, these directional samples can be taken from the same elasticized region from multiple pieces of the same composite material (e.g., three replicate directional samples may be obtained from the same stretch composite material found at the same location of three diapers). Typically, the chosen elasticized region is visually identified as the region having the highest density of elastomeric members. It is typical, though not required, to test more than one elasticized region to fully characterize the directional properties of the composite. Care should be taken that the three replicate samples are similar to one another. If the elasticized region is not large enough to provide these 1″ by 3″ (25.4 mm by 76.2 mm) samples, the largest possible sample size is used for testing, and the test method is adjusted accordingly. All surfaces of the sample should be free of visible flaws, scratches or imperfections.

(iii) Hysteresis Test For Elastomeric Members

A commercial tensile tester from Instron Engineering Corp., Canton, Mass. or SINTECH-MTS Systems Corporation, Eden Prairie, Minn. (or a comparable tensile tester) may be used for this test. The instrument is interfaced with a computer for controlling the test speed and other test parameters, and for collecting, calculating and reporting the data. The hysteresis is measured under typical laboratory conditions (i.e., room temperature of about 20° C. and relative humidity of about 50%).

The procedure for determining hysteresis of an elastomeric member involves the following steps:

1. choose the appropriate jaws and load cell for the test; the jaws should be wide enough to fit the sample, typically 1″ wide jaws are used; the load cell is chosen so that the tensile response from the sample tested will be between 25% and 75% of the capacity of the load cells or the load range used, typically a 50 lb load cell is used;

2. calibrate the tester according to the manufacturer's instructions;

3. set the gauge length at 1″ (25.4 mm);

4. place the sample in the flat surface of the jaws such that the longitudinal axis of the sample is substantially parallel to the gauge length direction;

5. set the cross head speed at a constant speed of 10″/min (0.254 m/min) until it reaches 112% strain; then return to the original gauge length at 10″/min (0.254 m/min); and at the end of this pre-straining cycle, start timing the experiment using a stop watch;

6. reclamp the pre-strained sample to remove any slack and still maintain a 1″ (25.4 mm) gauge length;

7. at the three minute mark on the stop watch, start the hysteresis test and the tester begins to record load versus strain data simultaneously; the hysteresis test specifically involves the following steps:

a) going to 75% strain at a constant rate of 10″/min (0.254 m/min);

b) allowing sample to remain at this strain for 2 minutes;

c) returning sample to 0% strain at a constant rate of 10″/min (0.254 m/min);

d) allowing sample to remain at this strain for 1 minute; and

e) going to 0.1 N at a constant rate of 2″/min (50.8 mm).

From the data collected in step 7(a), the elasticity is determined from the load at 75% strain, which is normalized to 85 grams per square meter (gsm) as follows: the load at 75% strain from the plot is divided by the width of the sample, then multiplied by a normalizing factor, which is 85 divided by the basis weight of the elastomeric material in gsm.

From the data collected in step 7(e), the % set is determined from the strain at 0.1 N, which is a force deemed sufficient to remove the slack but low enough to impart, at most, insubstantial stretch to the sample.

From the data collected in step 7(b), the force relaxation is determined by the load at the beginning and at the end of the 2 minutes hold time using the following formula:

$$\% Stress Relaxation at time , t = \frac{[ ( initial load ) - ( load at time , t ) ]}{( initial load )} \times 100$$

For the elastomeric members, the average results from three replicate samples are reported.

(iv) Hysteresis Test For Elastomeric Composites

There is no pre-straining of the composite sample in this hysteresis test and the load at 75% strain is normalized to 85 gsm of the composite basis weight. In this test, steps 1-4 are performed as above; at the end of step 4, there is a one-minute holding at 0% strain; and steps 7(a-e) immediately follow.

The elastic properties are obtained from the recorded data. The directional elasticity is determined from the load at 75% strain, which is normalized to 85 grams per square meter (gsm) as follows: the load at 75% strain from the plot is divided by the width of the sample, then multiplied by a normalizing factor, which is 85 divided by the composite basis weight in gsm. The directional % set and the directional force relaxation are obtained form the data as described earlier. For the elastomeric composites, a directional property, such as “directional elasticity”, “directional % set” and “directional force relaxation”, is the average result of that property obtained from three replicate samples in one specific direction. Thus, a directional property is recorded in each of the four directions of the test samples.

### EXAMPLES

### Example 1

A phase change solvent having the general structure (I) is prepared by combining 260 grams (2 moles) of octanol with 404 grams (2 moles) of terephthaloyl chloride and 202 grams (1 mole) of 1,12-dodecanediol in 1500 ml of chloroform in a reaction flask. The mixture is allowed to react at 55° C. for 20 hours with constant stirring and under a vacuum, which removes HCl generated by the reaction. The reaction is terminated by cooling the mixture to room temperature. The resulting reaction mixture is poured into a large quantity of methanol to precipitate the product. The precipitant is collected over a filter, washed with 500 ml of methanol 3 times (i.e., 1500 ml total) and dried at 45° C. in an vacuum oven for 20 hours.

An elastomeric composition is prepared by mixing and stirring this phase change solvent and SEPTON® S4033 (available from Kuraray America, Inc., New York, N.Y.) at 120° C. for 4 hours or until the sample appears to be homogeneous. The mixture is cooled to room temperature. Mineral oil, DRAKEOL® Supreme (available from Pennzoil Co., Penrenco Div., Karns City, Pa.) is then added to the mixture and stirred at room temperature for 16-24 hours to form an elastomeric composition. For this example, the final elastomeric composition contains 40 wt % SEPTON® S4033, 30 wt % phase change solvent and 30 wt % mineral oil. This elastomeric composition has a melt viscosity of about 24 Pa#s at 175° C. and 1 s⁻¹

The above blending method is merely exemplary. Other conventional blending methods using batch mixers, screw extruders, and the like, can also be used.

### Example 2

The elastomeric composition of Example 1 is processed through a direct gravure system (available from Roto-therm Inc., Redding Calif.) at a temperature of about 175° C. The direct gravure system includes a tank, a bath, hoses, a patterned steel roll (i.e., the gravure roll) and a back-up roll. The tank holds the elastomeric composition; the tank is connected to the hoses which serve as the conduits for transporting the elastomeric composition to the bath. All these components are heated to about 175° C. so that the elastomeric composition is maintained at a fairly constant temperature during the printing process. The gravure roll is 9.3″ (0.236 m) in diameter and is also heated to about 175° C. The gravure roll has grooves and lands on its surface for depositing the elastomeric composition onto a substrate in a continuous trihelical pattern not shown in FIG. 4. The grooves are 0.020″ (0.51 mm) wide and 0.0075″ (0.19 mm) deep and the land width is 0.023″ (0.58mm). Total width of the pattern on the gravure roll is 5″ (0.127 m). The back-up roll is 6.25″ (0.158 m) in diameter and is made of silicone rubber to have a hardness of 55 Shore A. The substrate is a HEC polypropylene nonwoven web (available from BBA Nonwovens Inc. of South Carolina) having a basis weight of about 22 grams per square meter.

Referring to FIG. 4, a substrate 34 is unwound from a first supply roll 52 and is fed between the gravure printing roll 54 and the back-up roll 56, both operating at a line speed of 50-200 feet per minute and with a nip pressure of 6-12 mm. Nip pressure is quantified in terms of a footprint, which is the impression that the printing roll makes on the backup roll. The footprint can vary from about 3 mm to 24 mm using this equipment. Proper nip pressure is chosen to effectuate the transfer of the composition from the gravure roll to the substrate and to control the penetration of the composition into the substrate. Transfer efficiency, which is the fraction of the grooves that are emptied, typically ranged from about 40-60%. The gravure printing roll 54 picks up the elastomeric composition from the heated bath (not shown) to fill grooves 58 on the roll surface, then transfers the composition directly to the substrate to form a printed substrate 35 having printed members 60. A second substrate 36, which is the same nonwoven web as the first substrate 34, is unwound from a second supply roll 62 and combined with the printed substrate 35 between two rubber nip rolls 64, 66, thereby forming the intermediate structure 37. Nip pressure, temperature, and contact time can be adjusted to give optimum bonding.

The intermediate structure is subjected to incremental stretching in one or more portions by pressing said portions between two interengaging grooved plates, one stationary and the other movable. The plates are at least 4″×4″ in dimension and are made of stainless steel. The pitch, which is the distance between adjacent teeth on a plate, is 1.524 mm; the tooth height is 10.31 mm; the tooth tip radius is 0.102 mm; and the depth of engagement (DOE), which is the distance between two adjacent tooth tips from two teeth on opposed, interengaging plates that controls how deeply the teeth are engaged, is 3.639 mm.

The intermediate structure is placed on the stationary plate; the movable plate approaches and engages with the stationary plate at a speed of 1.82 m/s. Upon reaching the desired DOE, the movable plate reverses and returns to its original position. Thus, by varying the portion and/or the direction the composite preform placed in between the grooved plates and/or by varying the DOE, the resulting composite can have incremental stretching to a varying extent, in any portion thereof and in any orientation.

### Example 3

The process is similar to that of Example 2, except an off-set gravure printing process is used. The elastomeric composition is first transferred from the gravure printing roll to a silicone release paper (available from Waytek Corporation, Springboro, Ohio) and then substrate 34 is nipped in between an additional set of rubber rolls to get complete transfer from the release paper to the substrate. Since these rubber rolls are not heated, the elastomeric composition is cooled during this off-set printing step such that it contacts the substrate at a temperature lower than the processing temperature of 175° C. yet it is still sufficiently fluid to at least partially penetrate the nonwoven substrate. There is a reduced likelihood of thermal damage to the delicate structure of the nonwoven substrate due to the lower temperature at contact.

### Comparative Examples

Comparative examples are made from blends of SEPTON® S4033, mineral oil, DRAKEOL® Supreme, and VECTOR® 4211 (available from Dexco Chemical Company, Houston, Tex.). The blends can be prepared by the methods described in Example 1 or any conventional blending methods. Comparative example 1 is a blend of 60 wt % VECTOR® 4211 and 40 wt % mineral oil. Comparative example 2 is a blend of 55 wt % VECTOR® 4211 and 45 wt % mineral oil. Conparative example 3 is a blend of 30 wt % SEPTON® S4033 and 70 wt % mineral oli. Comparative example 4 is a blend of 35 wt % SEPTON® S4033 and 65 wt % mineral oil. Comparative example 5 is a blend of 40 wt % SEPTON® S4033 and 60 wt % mineral oil. Comparative example 6 is a hot melt adhesive H2737, available from Bostik Findley, Middletown, Mass. Comparative example 7 is a metallocene-catalyzed polyethylene ENGAGE® ENR 8407, available from Dow Chemical Company of Midland, Mich.

Film sample of the comparative examples and Example 1 of the present invention are prepared and subjected to the hysteresis test described above. The results are reported below.

TABLE 1

| | | | | Force | |
|---|---|---|---|---|---|
| | | Melt | Elasticity | Relaxation | |
| | | Viscosity | (Normalized | (75% Strain, | |
| | Basis | (175° C., | * Load at | 2 min., room | |
| | Weight. | 1 s⁻¹) | 75% Strain) | temp.) | % set |
| | (gsm) | (Pa s) | (N/m) | (%) | (%) |
| Example 1 | 198 | 24 | 99.40 | 19.8 | 3.7 |
| Comparative | | | | | |
| examples | | | | | |
| 1 | 158 | 630 | 12.76 | 8.1 | 6.8 |
| 2 | 224 | 484 | 13.75 | 5.4 | 5.0 |
| 3 | 232 | 21 | 14.52 | 8.7 | 6.1 |
| 4 | 225 | 40 | 18.78 | 7.9 | 4.6 |
| 5 | 141 | 203 | 25.15 | 6.8 | 4.6 |
| 6 | 200 | 7 | 14.50 | 7.4 | 5.0 |
| 7 | 175 | 490 | 190.55 | 24.9 | 6.8 |

* Normalized to a basis weight of 85 grams per square meter.

Table 1 shows that most comparative examples do not have the desired melt viscosity suitable for the controlled deposition processes used herein to produce the stretch composites. Further, for those comparative examples that have a suitably low melt viscosity, they exhibit a substantial trade-off in properties, resulting in unsatisfactory elastic properties. Example 1 of the present invention successfully provides the desired melt viscosity suitable for the processes used herein without compromising the elastic properties.

All documents cited in the Detailed Description of the Invention are, in relevant part, incorporated herein by reference; the citation of any document is not to be construed as an admission that it is prior art with respect to the present invention.

While particular embodiments and/or individual features of the present invention have been illustrated and described, it would be obvious to those skilled in the art that various other changes and modifications can be made without departing from the spirit and scope of the invention. Further, it should be apparent that all combinations of such embodiments and features are possible and can result in preferred executions of the invention. Therefore, the appended claims are intended to cover all such changes and modifications that are within the scope of this invention.

What is claimed is:

1. A process for making a stretch composite from an extensible substrate, said process comprising the steps of:
a. providing a first extensible substrate;
b. printing one or more elastomeric compositions, said compositions having a melt viscosity of from about 1 to about 400 Pa#s, measured at 175° C. and 1 s⁻¹ strain rate, an elasticity of at least about 50 N/m at 20° C., and a force relaxation of less than about 20%, onto said substrate thereby forming one or more intermediate structures; and
c. incrementally stretching one or more portions of the intermediate structures to permanently elongate the substrate in the portions.

2. The process of claim 1 wherein said process further comprises after printing a step of converting the elastomeric compositions into elastomeric members.

3. The process of claim 2 wherein the converting comprises one or more processes selected from the group consisting of crosslinking, curing, cooling, pressing, and combinations thereof.

4. The process of claim 1 wherein the elastomeric compositions comprise a thermoplastic elastomer and a phase change solvent having a weight ratio of from about 10:1 to about 1:1.

5. The process of claim 4 wherein the thermoplastic elastomer is selected form the group consisting of styrenic block copolymers, metallocene-catalyzed polyolefins, polyesters, polyurethanes, polyether amides, and combinations thereof; and the phase change solvent has the following formula:
R′-L_{y}-(Q-Lₓ)ₙ₋₁-Q-L_{y}-R; (I)
R′-L_{y}-(Q-Lₓ)ₙ-R; (II)
R′-(Q-Lₓ)ₙ-R; (III)
R′-(Q-Lₓ)ₙ₋₁-Q-L_{y}-R; (IV)
R′-(Q-Lₓ)ₙ₋₁-Q-R ; or (V)
a mixture thereof;
wherein Q may be a substituted or unsubstituted difunctional aromatic moiety; L is CH₂; R and R′ are the same or different and are independently selected from H, CH3, COOH, CONHR₁, CONR₁R₂, NHR₃, NR₃R₄, hydroxy, or C1-C30 alkoxy; wherein R₁, R₂, R₃ and R₄ are the same or different and are independently selected from H or linear or branched alkyl from C1-C30; x is an integer from 1 to 30; y is an integer from 1 to 30; and n is an integer from 1 to 7.

6. The process of claim 1 wherein the incrementally stretched portion of the stretch composite exhibits the following properties in at least one direction:
a directional elasticity of from about 5 N/m to about 400 N/m;
a directional percent set of less than about 20%; and
a directional force relaxation of less than about 30% after 2 minutes at room temperature and 75% strain.

7. The process of claim 1 wherein the composite comprises one or more elasticized regions of an absorbent article.

8. The process of claim 7 wherein the one or more elasticized regions of the absorbent article is selected from the group consisting of an elasticized waist region, an elasticized cuff region, an elasticized side panel, an elastic ear portion, an elasticized outercover, an elasticized topsheet, a fastener system, and combinations thereof.

9. The process of claim 1 wherein prior to incremental stretching said process further comprises a step of
laminating a second substrate to the first extensible substrate with the one or more elastomeric members sandwiched between the first and second substrates.

10. The process of claim 2 wherein the elastomeric members are different in a characteristic selected from the group consisting of compositions, add-on levels, shape, pattern, and combinations thereof.

11. The process of claim 2 wherein the elastomeric members are rectilinear or curvilinear, and at least two of the elastomeric members are non-parallel with respect to each other.

12. The process of claim 7 wherein the one or more elasticized regions are adjacent or at least partially overlapping.

13. A process for making a stretch composite comprising the steps of:
a. providing at least one neckable, inelastic substrate;
b. applying a tensioning force to the neckable, inelastic substrate to form a necked, inelastic substrate;
c. printing one or more elastomeric compositions, said compositions having a melt viscosity of from about 1 to about 400 Pa#s, measured at 175° C. and 1 s⁻¹ strain rate, an elasticity of at least about 50 N/m at 20° C., and force relaxation of less than about 20%, onto said substrate to form a stretch composite.

14. The process of claim 13 further comprising a step of
bonding a second necked, inelastic substrate to the stretch composite.

15. The process of claim 13 further comprising a step of
incrementally stretching one or more portions of the stretch composite.

16. The process of claim 13 wherein the neckable, inelastic substrate is incrementally stretched, at least in one or more portions, prior to applying a tensioning force.

17. The process of claim 15 further comprising a step of
bonding a second necked, inelastic substrate to the stretch composite.

18. The process of claim 16 further comprising a step of
incremental stretching of one or more portions of the stretch composite.
